(19) United States
(12) Patent Application Publication
(10) Pub. No.: US 2007/0050793 A1
(43) Pub. Date: Mar. 1, 2007

(54) OPTICAL DISC DRIVE AND SOUNDPROOF STRUCTURE THEREOF

(75) Inventor: Hsin-Tso Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 11/467,567

(22) Filed: Aug. 28, 2006

(30) Foreign Application Priority Data
Aug. 30, 2005 (TW) 94129618

(51) Int. Cl. G11B 33/14

(52) U.S. Cl. 720/648

(57) ABSTRACT

An optical disc drive and a soundproof structure thereof are provided. The optical disc drive includes a case, a tray and a door. The case has a panel, which with the door forms the soundproof structure. The panel has an opening, an outer surface and at least a first rib on the outer surface and near the opening. The tray is in the case, the tray carrying an optical disc to enter and eject from the case through the opening. The door is disposed on the front border of the tray, having at least a second rib on a surface opposite to the outer surface of the panel, leaning against the outer surface of the panel away from the first rib by a gap. A noise transmitted outwards is reduced through a space encolsed by the first and second rib.

### CROSS-REFERENCE TO RELATED APPLICATION

This application claims the priority benefit of Taiwan application serial no. 94129618, filed on Aug. 30, 2005. All disclosure of the Taiwan application is incorporated herein by reference.

### BACKGROUND OF THE INVENTION

1. Field of Invention

The present invention relates to a soundproof structure. More particularly, the present invention relates to an optical disc drive with soundproof structure.

2. Description of Related Art

FIG. 1 is a three-dimensional schematic view of a conventional optical disc drive. Referring to FIG. 1, a conventional optical disc drive 100 carries an optical disc 50 by a tray 130. When users use the optical disc drive 100 to read the information recorded in the optical disc 50, the tray 130 needs to be ejected from the case 110, so that the optical disc 50 can be put on the tray 130. After the optical disc 50 is put on the tray 130, the tray 130 enters the case 110, so that the optical disc pick up head (not shown) in the case 110 can read the information recorded in the optical disc 50.

However, when the optical disc 50 is rotating in high speed within the optical disc drive 100, the optical disc 50 may create a wind shear effect with the surround air, causing noise. And, the main pivot motor (not shown) may generate vibration noise when rotating in high frequency. Both factors cause noises in the entire optical disc drive 100. Therefore, how to reduce the noise during the operation of the optical disc drive has been an important research topic.

### SUMMARY OF THE INVENTION

Accordingly, the present invention is directed to provide a soundproof structure, which can be applied in the optical disc drive to reduce the noise of the optical disc drive.

Another aspect of the present invention is to provide an optical disc drive, which can reduce the self-generated noise effectively.

According to the above and other aspects, the present invention provides a soundproof structure, including a panel and a door. The panel has an opening, an outer surface and at least a first rib, wherein the first rib is disposed on the outer surface and near the opening. The door has at least a second rib, wherein the second rib is disposed on a surface opposite to the outer surface of the panel, and leaning against the outer surface of the panel away from the first rib by a gap.

In the soundproof structure according to the embodiment of the present invention, the second rib is farther than the first rib with respect to the opening of the panel.

In the soundproof structure according to the embodiment of the present invention, the door, for example, further includes at least a third rib, wherein the third rib leans against the outer surface of the panel, and, the third rib and the second rib enclose a media isolation room. Further, the third rib, for example, surrounds the opening of the panel and farther than the second rib with respect to that.

For the soundproof structure according to the embodiment of the present invention, the outer surface of the panel has at least an orientating groove, and part of the second rib can be embedded into the orientating groove.

In the soundproof structure according to the embodiment of the present invention, the door, for example, further has at least a fourth rib closer than the first rib with respect to the opening of the panel, and a sound wave path is formed between the fourth rib and the first rib.

The soundproof structure according to the embodiment of the present invention further includes a soundproof material disposed on the panel or one side of the first rib of the door.

According to the above and other aspects, the present invention provides an optical disc drive, including a case, a tray and a door. The case has a panel, and the panel has an opening, an outer surface and at least a first rib, wherein the first rib is disposed on the outer surface and near the opening. The tray is disposed in the case, and the tray is suitable for carrying an optical disc to enter and eject from the case via the opening. The door is disposed on the front border of the tray, and has at least a second rib, wherein the second rib is disposed on a surface opposite to the outer surface of the panel, leaning against the outer surface of the panel away from the first rib by a gap.

In the optical disc drive according to the embodiment of the present invention, the second rib, for example, is farther than the first rib with respect to the opening of the panel.

In the optical disc drive according to the embodiment of the present invention, the door, for example, further includes at least a third rib, wherein the third rib leans against the outer surface of the panel, and the third rib and the second rib enclose a media isolation room. Further, the third rib, for example, surrounds the opening of the panel, and, for example, is farther than the second rib with respect to that.

In the optical disc drive according to the embodiment of the present invention, the outer surface of the panel, for example, further has an orientating groove, so that part of the second rib can be embedded into the orientating groove.

For the optical disc drive according to the embodiment of the present invention, the door, for example, further has at least a fourth rib closer than the first rib with respect to the opening of the panel, and a sound wave path is formed between the fourth rib and the first rib.

The optical disc drive according to the embodiment of the present invention further includes a soundproof material disposed on the panel or one side of the first rib of the door.

In summary, in the soundproof structure and the optical disc drive of the present invention, as the second rib on the door leans against the outer surface of the panel away from the first rib by a gap, a space can be formed to reduce the noise transmitted outwards in the optical disc drive.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial three-dimensional schematic view of a conventional optical disc drive.

FIG. 2A is a three-dimensional schematic view of an optical disc drive according to one embodiment of the present invention.

FIG. 2B is a three-dimensional schematic view of the panel in FIG. 2A from a different angle.

FIG. 2C is a three-dimensional schematic view of the door in FIG. 2A from a different angle.

FIG. 2D is a top perspective view of the panel and the door of the optical disc drive in FIG. 2A.

FIG. 2E is a top perspective view of the door leaning against the panel in FIG. 2D.

FIGS. 3A, 3C and 3D are schematic views corresponding to the soundproof material disposed in FIG. 2D.

FIG. 3B is a schematic view corresponding to the soundproof material disposed in FIG. 2E.

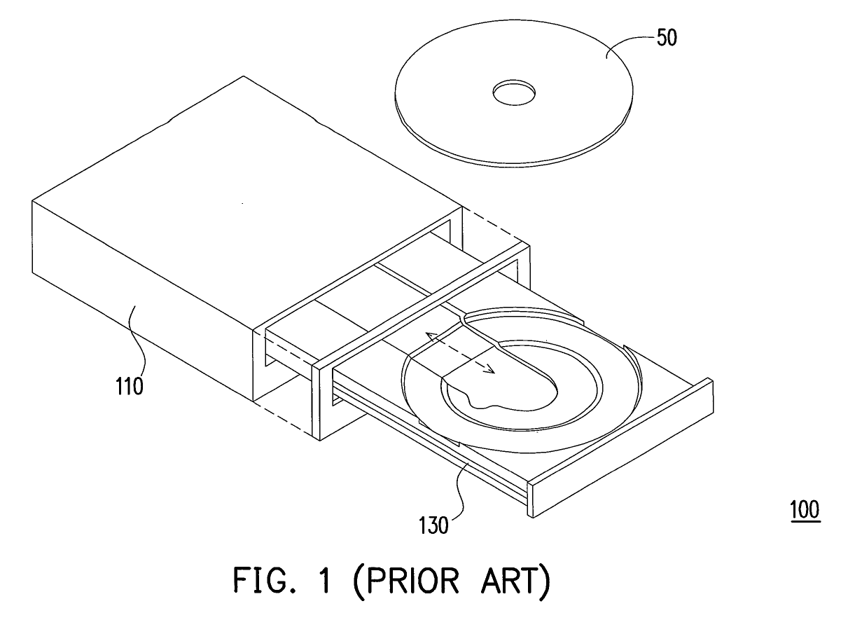

### DESCRIPTION OF EMBODIMENTS

The following takes the optical disc drive as an example accompanied with figures to explain the features of the soundproof structure of the present invention.

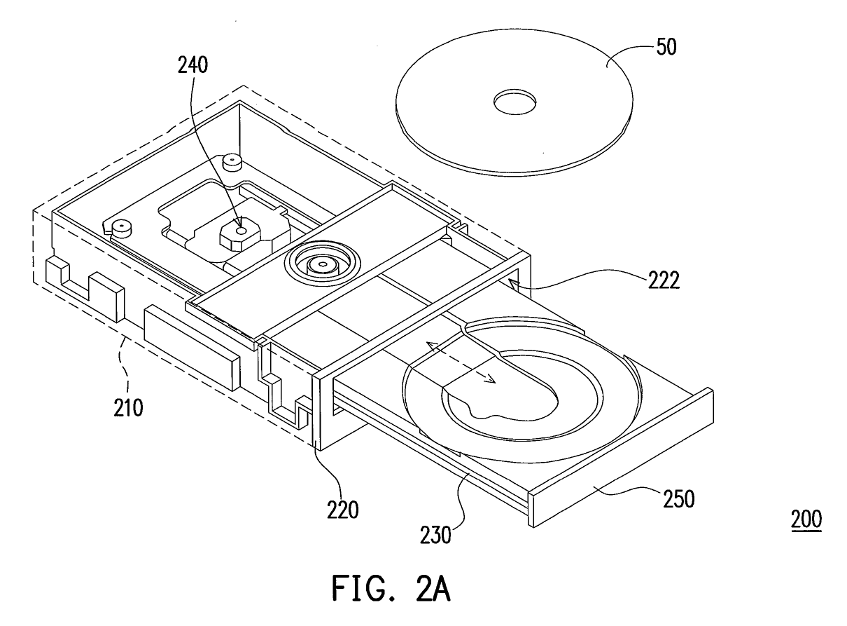

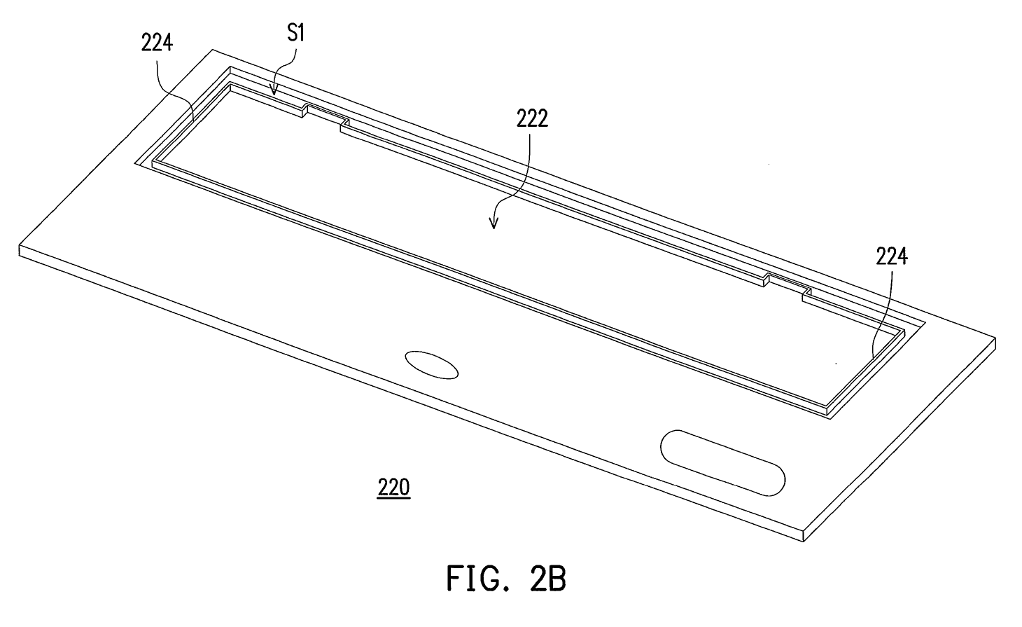

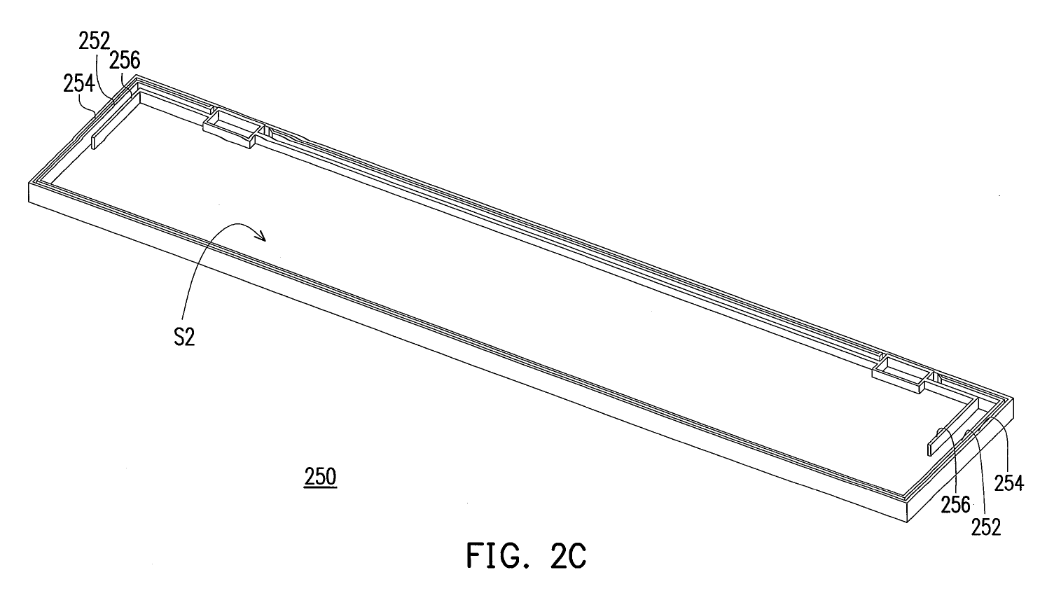

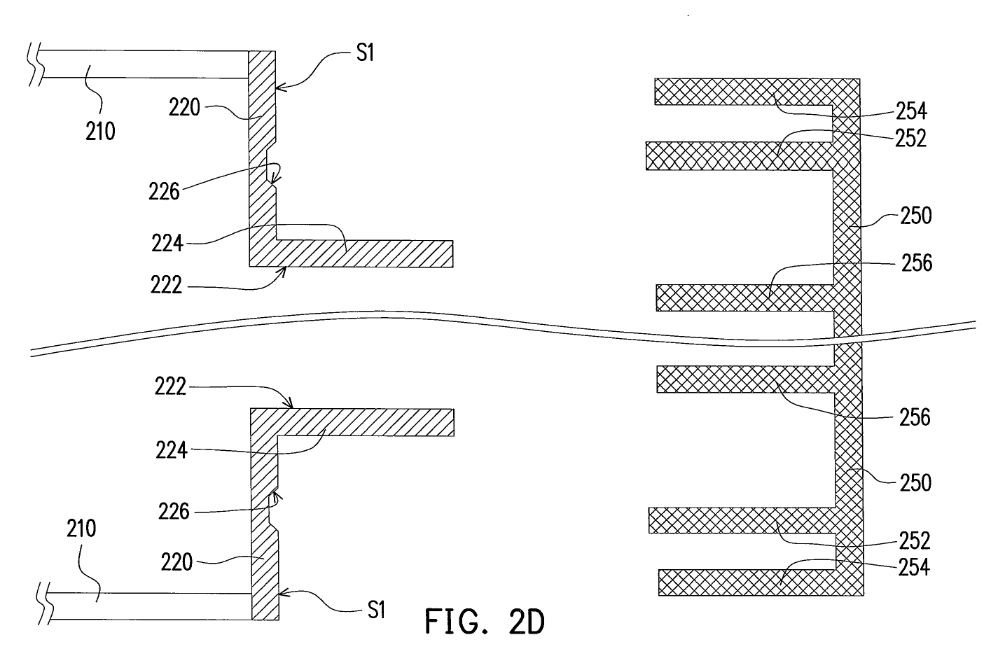

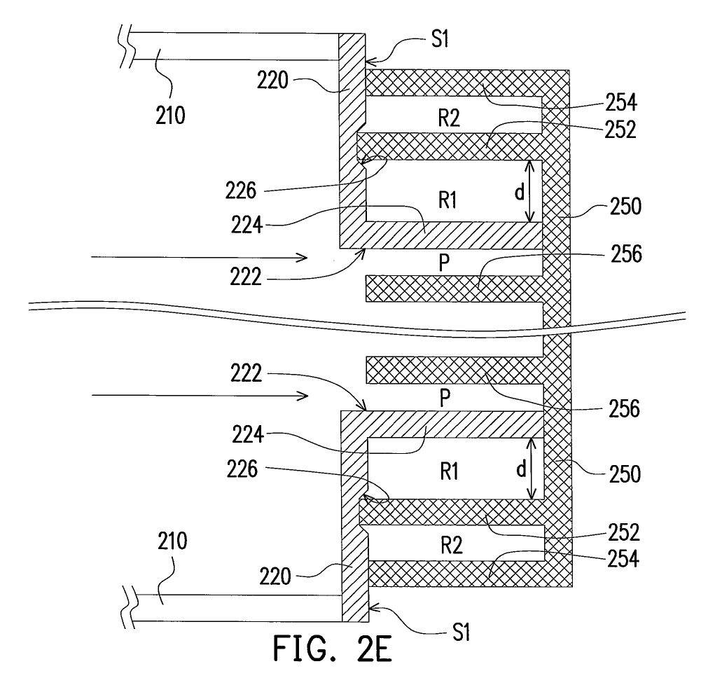

FIG. 2A is a three-dimensional schematic view of an optical disc drive according to one embodiment of the present invention. Referring to FIG. 2A, the optical disc drive 200 of the present invention mainly includes a case 210, a tray 230, an optical disc reading module 240 and a door 250. The case 210 has a panel 220. The panel 220 has an opening 222 through which the tray 230 enters and ejects from the case 210. The tray 230 and the optical disc reading module 240 are disposed in the case 210. When the tray 230 carrying an optical disc 50 enters the case 210, the optical disc reading module 240 can read the information recorded in the optical disc 50. In the other hand, when the tray 230 is ejected from the case 210, users can replace the optical disc. The door 250 is disposed on the front border of the tray 230, and is corresponding to the opening 222 of the panel 220. And, when the tray 230 enters the case 210, the door 250 may lean against the panel 220 to close the opening 222 of the panel 220, and accordingly, a soundproof structure can be formed between the door 250 and the panel 220. In order to further explain the theory and the efficacy of the soundproof structure of the present invention, the following is a description of the structures of the panel 220 and the door 250 of the present invention and the soundproof structure formed by integrating the panel 220 with the door 250.

FIG. 2B is a three-dimensional schematic view of the panel 220 in FIG. 2A from a different angle, and FIG. 2C is a three-dimensional schematic view of the door 250 in FIG. 2A from a different angle. First, referring to FIG. 2B, the panel 220 has an opening 222, an outer surface S1 and a first rib 224, wherein the first rib 224 is disposed on the outer surface S1 and near the opening 222. Referring to FIG. 2C, the door 250 has an inner surface S2 and a second rib 252, and may further have a third rib 254 and a fourth rib 256. The following is accompanied with figures to explain the combination of the panel 220 and the door 250 of the soundproof structure of the present invention.

FIG. 2D is a cross-sectional top view of the panel 220 and the door 250 of the optical disc drive in FIG. 2A, and FIG. 2E is a schematic view further showing the combination of the door 250 and the panel 220 in FIG. 2D. Referring to FIG. 2A and FIG. 2D, when the tray 230 is ejected from the case 210, the door 250 is detached from the panel 220. Referring to FIG. 2D and FIG. 2E, when the tray 230 enters the case 210, the tray 230 may bring the door 250 to lean against the panel 220 to close the opening 222 of the panel 220. At this time, the second rib 252 of the door 250 may lean against the outer surface S1 of the panel 220 away from the first rib 224 of the panel 220 by a gap d, so accordingly an enclosing media isolation room R1 is formed for soundproofing. As the media isolation room R1 is almost a closed space when the door 250 is integrated with the panel 220, when the sound wave generated in the optical disc drive 200 enters the isolation room R1, the power of the sound wave may be consumed when passing toward and backward. Accordingly, the media isolation room R1 can reduce the power and amplitude of the sound wave, especially the sound wave of middle and high frequency, and the noise transmitted outwards in the optical disc drive 200 is effectively reduced. Note that the first rib 224 and the second rib 252 which enclose the media isolation room R1 are not to be construed in a limiting sense as to the relative positions of each other. For example, the positions of the first rib 224 and the second rib 252 can be exchanged. That is, the first rib 224 can be integrated with the panel 220 at the original position of the second rib 252, and also, the second rib 252 can be integrated with the door 250 at the original position of the first rib 224.

In the embodiment, the second rib 252 is farther than the first rib 224 with respect to the opening 222 of the panel 220. However, in other embodiments, the second rib 252 can be also closer than the first rib 224 with respect to the opening 222 of the panel 220, and the second rib 252 and the first rib 224 enclose a media isolation room. The above configurations should to obvious to those skilled in the art so figures are omitted here.

Moreover, in order to have more precise alignment between the panel 220 and the door 250, an orientating groove 226 is further formed on the outer surface S1 of the panel 220 corresponding to the second rib 252. When the door 250 leans against the panel 220, part of the second rib 252 may be embedded into the orientating groove 226 to fix the relative distance between the door 250 and the panel 220. Accordingly, the vibration generated during the operation of the optical disc drive 200, which may change the relative distance between the door 250 and the panel 220, can be avoided. Further, the closeness of the media isolation room R1 can be maintained to reduce the noise. However, in other embodiments, the orientating groove can also be formed on the inner surface S2 of the door 220 corresponding to the first rib 224, so that part of the first rib 224 may be embedded into the orientating groove. The above configurations should be obvious to those skilled in the art, so figures are omitted here.

Referring to FIG. 2D and FIG. 2E, in order to further reduce the noise of the optical disc drive of the present invention, the door 250 has, for example, at least a third rib 254 leaning against the outer surface S1 of the panel 220 and surrounding the opening 222 of the panel 220. In the embodiment, the third rib 254 is, for example, farther than the second rib 252 with respect to the opening 222, and, the third rib 254 and the second rib 252 enclose a media isolation room R2. The media isolation room R2 has the same function as the media isolation room R1 in reducing the energy and amplitude of the sound wave. However, the media isolation room R1 may has different or same volume from the media isolation room R2. For example, the volume of the media isolation room R1 and the media isolation room R2 may be equal so as to serve as double isolation function. And, the volume of the media isolation room R1 may be greater than or less than the volume of the media isolation room R2, so that they can serve as isolation for different sound frequency to reduce the noise more effectively.

Note that the present invention does not limit the quantity of the media isolation rooms. For example, more ribs may be disposed on the panel or the door, and accordingly, these ribs can enclose a plurality of media isolation rooms, so that the noise generated in the optical disc drive can be reduced in each media isolation room. Moreover, the present invention does not have any limitation in the types of the media in the media isolation rooms. Note that as the media isolation room is almost a closed space, the structure can also prevent the external dust from entering the optical disc drive. Therefore, the dust can be avoided from interfering the optical disc drive when reading data, which helps keep the stable efficiency of the optical disc drive.

Referring to FIG. 2D and FIG. 2E, in order to lead the noise generated in the optical disc drive into the media isolation room to be eliminated effectively, the door 250 has, for example, at least a fourth rib 256. Wherein, the fourth rib 256 is farther than the first rib 224 with respect to the opening 222 of the panel 220. And, a sound wave path P is formed between the fourth rib 256 and the first rib 224, and accordingly, the noise generated in the optical disc drive 200 will pass through the sound wave path P and the first rib 224 and be transmitted into the media isolation room R1, so that the energy and amplitude of the sound wave can be reduced by the media isolation room R1. Note that the noise generated in the optical disc drive 200 of the present invention is 2.98 db accordingly a result of an experiment less than the optical disc drive without a soundproof structure, so that the optical disc drive 200 of the present invention can indeed reduce the noise effectively.

In addition, in order to further reduce the noise for the optical disc drive of the present invention, a soundproof material can be attached on the door of the optical disc drive to absorb the sound waves generated inside the optical disc drive.

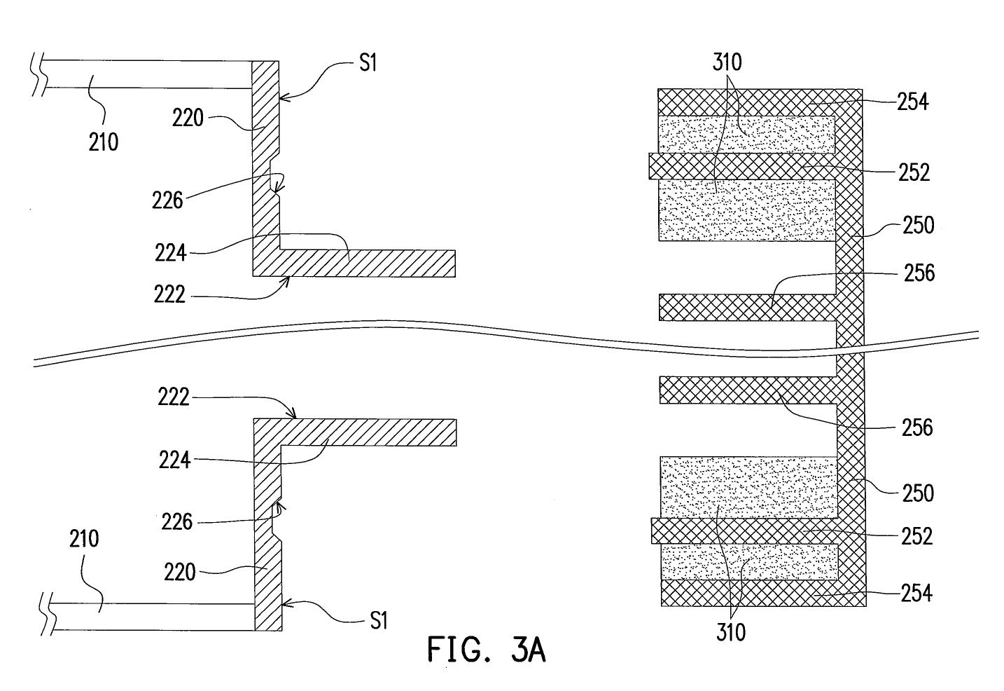

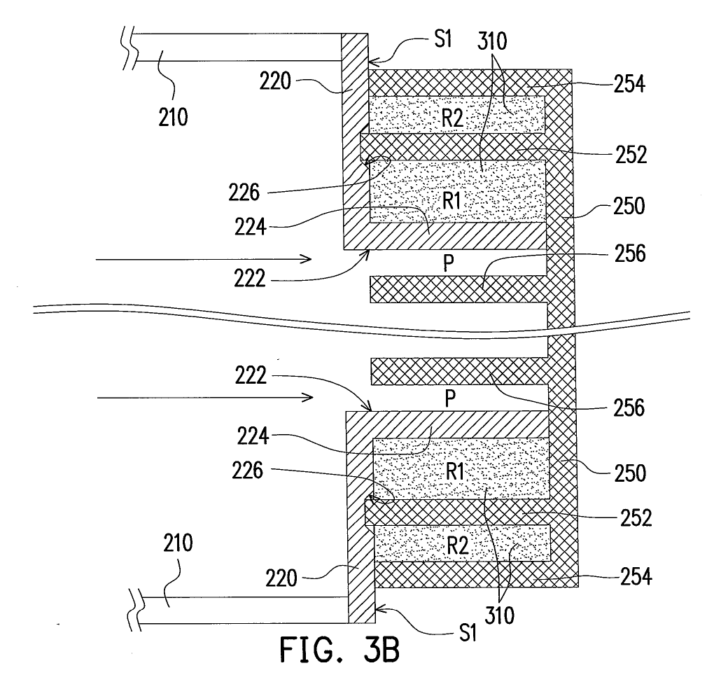

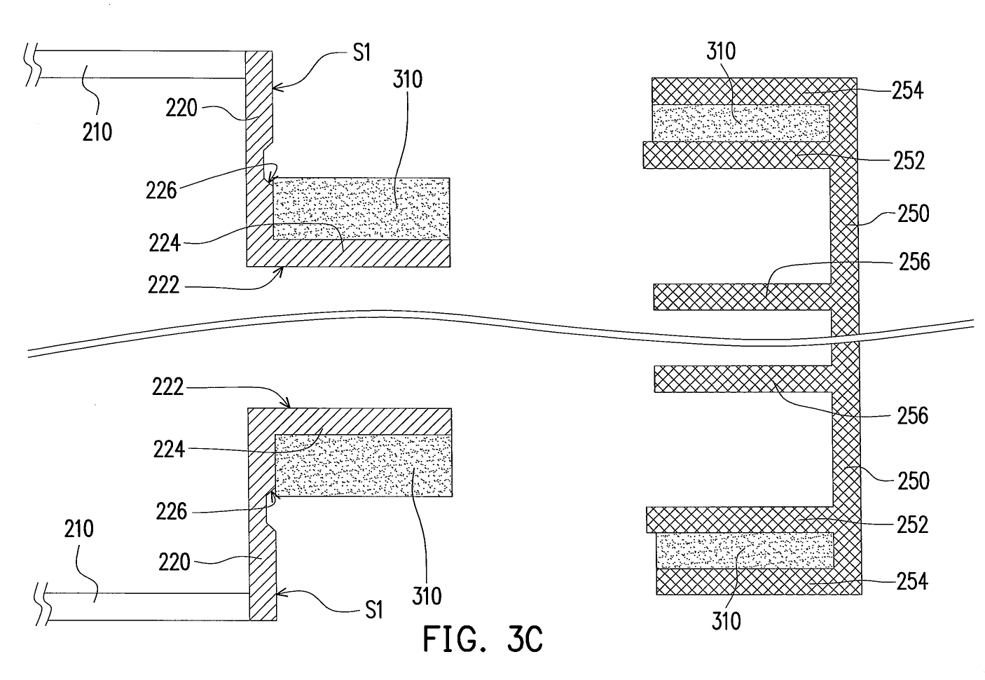

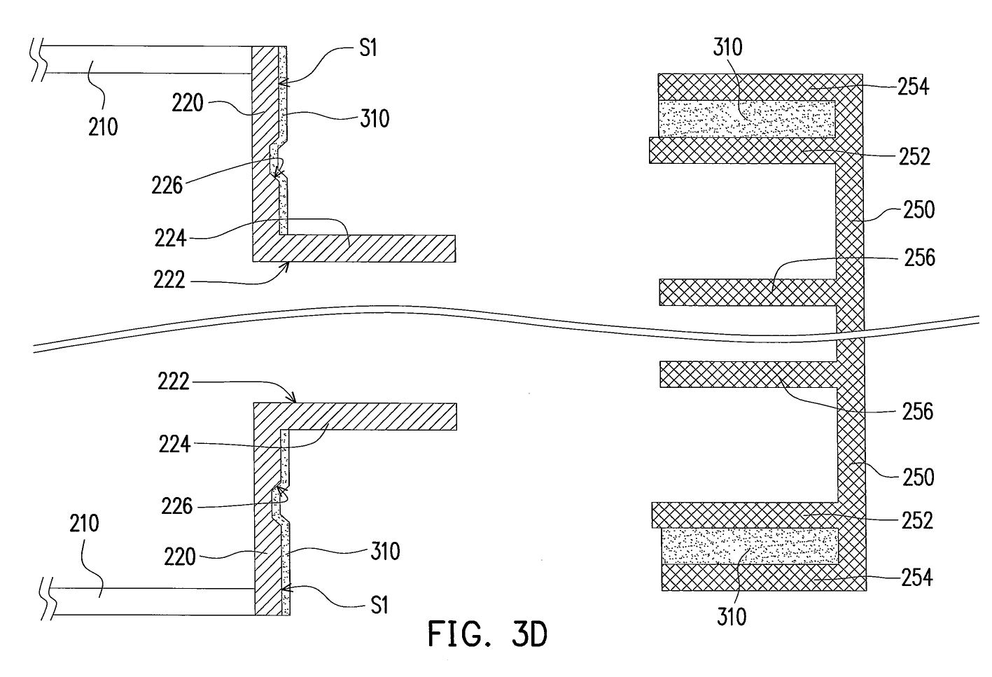

FIG. 3A and FIG. 3B are schematic views corresponding to the soundproof material configuration in FIG. 2D and FIG. 2E. Referring to FIG. 3A, first, in the present invention, for example, a plurality of soundproof materials 310 are attached on the sides of the second rib 252 and the third rib 254 of the door 250. Wherein, the soundproof material 310 can be a sound-absorbing sponge made of a rubber vesicant material or a mylar sheet. When the noise passes in the soundproof material 310 and causes vibration and friction, the soundproof material 310 can consume the energy of the noise, and accordingly, the noise generated in the optical disc drive 200 can be reduced. Referring to FIG. 3B, when the door 250 leans against the panel 220 and forms the media isolation rooms R1 and R2, the soundproof material 310 is disposed in the media isolation rooms R1 and R2. When the sound wave generated in the optical disc drive passes in the media isolation rooms R1, R2, all of the media isolation rooms R1, R2 and the soundproof material 310 can absorb the sound wave to reduce the energy and amplitude of the sound wave, and accordingly, the sound transmitted outwards in the optical disc drive 200 can be further reduced.

However, the soundproof material 310 is not limited to being attached on the door 250, and can also be attached on the panel 220. For example, it can be attached on the side of the first rib 254 of the panel 220, as shown in FIG. 3C. Of course, the soundproof material 310 can also be attached on the outer surface S1 of the panel 220, as shown in FIG. 3D. Accordingly, the door 250 can lean against the panel 220 more firmly to prevent the noise from transmitting outwards in the optical disc drive 200. Further, the present invention does not limit the attachment position of the soundproof material 310. For example, the soundproof material 310 can also be attached on the sides of the fourth rib 256 of the door 250, the inner surface of the door 250 or other positions suitable for absorbing the sound waves.

Note that, the soundproof structure of the optical disc drive 200 of the embodiment is formed by the media isolation room R1 surrounded by the ribs of the panel 220 and the door 250. However, the soundproof structure is not limited to being used in optical disc drive.

In summary, the optical disc drive and the soundproof structure have at least the following advantages:

1. The noise transmitted outwards in the optical disc drive can be reduced by the soundproof structure design of the media isolation room surrounded by the ribs of the panel and the door.

2. The almost closed structure of the media isolation room can prevent dust from entering the optical disc drive, and accordingly, the stable efficiency of the optical disc drive can be achieved.

3. A soundproof material can be configured on the panel and the door to absorb the sound wave, the noise transmitted outwards in the optical disc drive can be further reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A soundproof structure, comprising:
a panel, having an opening, an outer surface and at least a first rib, wherein the first rib is disposed on the outer surface and near the opening; and
a door, having at least a second rib, wherein the second rib is disposed on a surface of the door corresponding to the outer surface of the panel, and away from the first rib by a gap when the panel is integrated with the door.

2. The soundproof structure as claimed in claim 1, wherein the second rib is farther than the first rib and with respect to the opening.

3. The soundproof structure as claimed in claim 1, wherein the door further includes at least a third rib, and the third rib leans against the outer surface of the panel, and the third rib and the second rib enclose a media isolation room.

4. The soundproof structure as claimed in claim 3, wherein the third rib surrounds the opening.

5. The soundproof structure as claimed in claim 3, wherein the third rib is farther than the second rib with respect to the opening.

6. The soundproof structure as claimed in claim 1, wherein the outer surface of the panel has at least an orientating groove, and part of the second rib is embedded into the orientating groove.

7. The soundproof structure as claimed in claim 1, wherein the door further includes a fourth rib, and the fourth rib is closer than the first rib with respect to the opening, and a sound wave path is formed between the fourth rib and the first rib.

8. The soundproof structure as claimed in claim 1, further comprising a soundproof material disposed on the outer surface of the panel.

9. The soundproof structure as claimed in claim 1, further comprising a soundproof material disposed on one side of the second rib of the door.

10. An optical disc drive, comprising:
a case, having a panel, and the panel has an opening, an outer surface and at least a first rib, wherein the first rib is disposed on the outer surface near the opening;
a tray, disposed in the case and suitable for carrying an optical disc to enter and eject from the case through the opening; and
a door, disposed on the front border of the tray, having at least a second rib, wherein the second rib is disposed on the surface of the door opposite to the outer surface of the panel, and the second rib is away from the first rib by a gap when the panel is integrated with the door.

11. The optical disc drive as claimed in claim 10, wherein the second rib is farther than the first rib with respect to the opening.

12. The optical disc drive as claimed in claim 10, wherein the door further includes at least a third rib, and the third rib leans against the outer surface of the panel, and, the third rib and the second rib enclose a media isolation room.

13. The optical disc drive as claimed in claim 12, wherein the third rib surrounds the opening.

14. The optical disc drive as claimed in claim 12, wherein the third rib is farther than the second rib with respect to the opening of the panel.

15. The optical disc drive as claimed in claim 10, wherein the outer surface of the panel has at least an orientating groove, and part of the second rib is embedded into the orientating groove.

16. The optical disc drive as claimed in claim 10, wherein the door has at least a fourth rib, and the fourth rib is closer than the first rib with respect to the opening, and a sound wave path is formed between the fourth rib and the first rib.

17. The optical disc drive as claimed in claim 10, further comprising a soundproof material disposed on the outer surface of the panel.

18. The optical disc drive as claimed in claim 10, further comprising a soundproof material disposed on one side of the second rib of the door.

19. A soundproof structure, comprising:
a panel, having at least a first rib; and
a door, having at least a second rib, wherein the first rib and the second rib form at least a media isolation room when the panel is integrated with the door.
